(19) United States
(12) Patent Application Publication
(10) Pub. No.: US 2022/0076184 A1
(43) Pub. Date: Mar. 10, 2022

(54) EFFICIENT ONGOING EVALUATION OF HUMAN INTELLIGENCE TASK CONTRIBUTORS

(71) Applicant: DEFINEDCROWD CORPORATION, Seattle, WA (US)

(72) Inventors: Jorge Filipe Lopes Ribeiro, Seattle, WA (US); Rui Pedro dos Santos Correia, Seattle, WA (US); João Dinis Colaço de Freitas, Seattle, WA (US)

(21) Appl. No.: 17/014,557

(22) Filed: Sep. 8, 2020

(51) Int. Cl. G06Q 10/06

(52) U.S. Cl. CPC G06Q 10/06395; G06Q 10/06398

(57) ABSTRACT

A facility for assessing a crowdsourcing platform contributor is described. By combining a first probability value for the contributor with a source of randomness, the facility determines that a gold HIT should be presented to the contributor. In response, the facility presents a gold HIT to the contributor, and receives a response. Where the response is correct, the facility reduces the first probability value to obtain a second probability value, otherwise the facility decreases the first probability value to obtain the second probability value. The facility then determines whether a gold HIT or a regular HIT should next be presented to the contributor by combining the second probability value with a source of randomness.

### BACKGROUND

A crowdsourcing system automatically distributes instances of a given task (commonly referred to as “Human Intelligence Task” or simply “HIT”) to a group of human workers (or “contributors”) who execute instances of such tasks according to certain requirements or goals. Upon successful completion, contributors receive a reward such as a monetary sum that is based on the amount of submitted work.

Common types of Human Intelligence Tasks include finding entities in a text, annotating an image by drawing bounding boxes, providing natural language variants of a sentence by writing in a text field, or validating other contributors' answers.

A group of HITs that share the same purpose (instructions) and format (input/result types) is called a Job. For instance, a Job with the instructions “Count the number of people in the image,” has ‘image’ as input type, and ‘number’ as output type. Each HIT within a Job will have a different input instance. In the example above, each HIT addresses a different image.

In a Job, each HIT can be executed by several distinct contributors. Each solved instance of a HIT is called a HIT Execution. Each HIT Execution has a different instance of the result type according to the corresponding contributor's answer. In the example above, contributors' answer with a number representing their perception of the number of people in the image.

The intrinsic characteristics of the crowdsourcing environment often require quality control mechanisms. Poor quality work can be a result of both fraud (contributors exploiting the system for money) or lack of skills (for instance, language skills).

A commonly used quality control mechanism in crowdsourcing is to introduce gold tasks in between regular executions, typically without notification for the contributors. Gold HITs share the same instructions and format than the job they are designed for, but they also define the expected/correct answer. Upon submitting a Gold Execution, contributors' output is compared to the expected answer, allowing to infer their performance on the current job. The more Gold HITs a given contributor answers, the more reliable is the projection of their on-job output quality.

The analysis of the set of Gold Executions for each contributor can result in a multitude of actions, including being signaled for further investigation, being blocked from the current job, and work being discarded and not rewarded.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing the facility's performance of the Assignment Stage for a particular job in some embodiments.

FIG. 3 is a graph diagram showing a first combination of a suspicion kernel function with minimum and maximum suspicion used by the facility in some embodiments.

FIG. 4 is a graph diagram showing a second combination of a suspicion kernel function with minimum and maximum suspicion used by the facility in some embodiments.

FIG. 5 is a graph diagram showing a third combination of a suspicion kernel function with minimum and maximum suspicion used by the facility in some embodiments.

FIG. 6 is an architecture diagram showing a first architecture in which the facility is implemented in some embodiments.

FIG. 7 is an architecture diagram showing a second architecture in which the facility is implemented in some embodiments.

### DETAILED DESCRIPTION

The inventors have noted that the strategy used to assign Gold HITs in a job (the “Gold Strategy”) can significantly affect the performance of contributors. The inventors analyze performance of a Gold Strategy by two variables:
Cost: measures the proportion of executions in a Job that are Gold;
Reactivity: measures the number of regular executions performed by low quality contributors that end up being blocked.

In more detail, it is optimal to decrease the number of Gold HITs performed by good contributors (cost), while at the same time to detect low quality contributions as early as possible (reactivity). These two goals may conflict, as making the system more sensitive to quality variations, intuitively requires increasing the proportion of Gold HITs that are mixed along regular tasks.

A Gold Strategy for a job is defined by six elements:
Set of Gold HITs: actual gold tasks that will be distributed among regular executions;
Similarity Comparison Metric: function that measures the distance between the contributors' answers and the expected gold result, depending on the result type of the job. Common similarity measures include Exact Match, Levenshtein Distance, Word Error Rate, or Intersection Over Union;
Gold Score Combinator function that produces a score for any given contributor based on the set of Gold HITs answered. Commonly used functions include Simple Average or Weighted Average;
Minimum Support: minimum number of gold executions to trigger contributor evaluation;
Gold Score Threshold(s): one or more thresholds that, when reached, trigger certain penalizing actions for the contributor;
Assignment Method: strategy that dictates when a contributor is exposed to a Gold HIT.

The first five elements that define a Gold Strategy above are closely connected to the type of data collection (type of output and desired level of quality). The inventors have recognized that the assignment method, however, is not, and can be exploited to optimize the full performance of the Gold Strategy.

Common Gold HIT assignment strategies are Fixed Assignment and Flat Rate. In Fixed Assignment, a contributor is exposed to a Gold HIT every fixed number of regular tasks, for instance, every 5 regular tasks. In Flat Rate, on the other hand, there is a previously established percentage representing the probability of a contributor receiving a Gold HIT. In this case, if the probability is set to 10%, it is expected that, on average, contributors will receive a Gold HIT every 10 regular tasks. Both Fixed Assignment and Flat Rate strategies have the same performance with respect to the Gold Strategy variables of cost and reactivity.

To optimize the Gold HIT Assignment process for the variables of cost and reactivity, the inventors have conceived and reduced to practice a software and/or hardware facility that assigns Gold Executions using a per-contributor Gold HIT Assignment probability that it dynamically adapts according to on-job contributor performance (“the facility”). This probability of the next assignment task being a Gold HIT is called Suspicion. The facility operates its Dynamic Gold HIT Assignment Strategy in two stages: Assignment Stage and Update Stage.

By performing in some or all of the ways described above, the facility more efficiently and effectively discerns and resolves poor performance by contributors.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks.

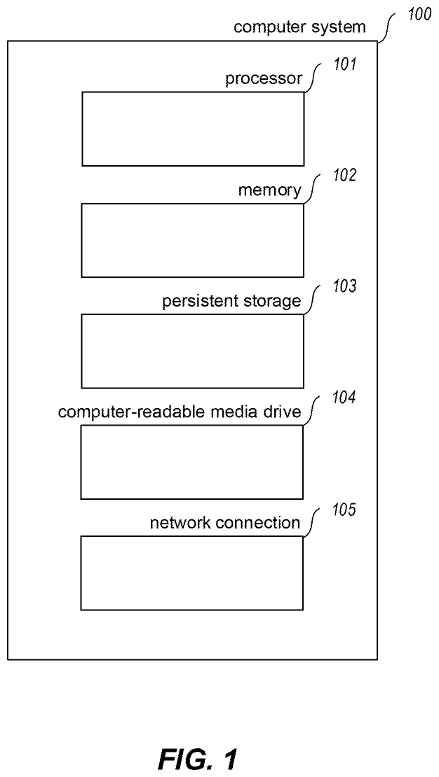

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

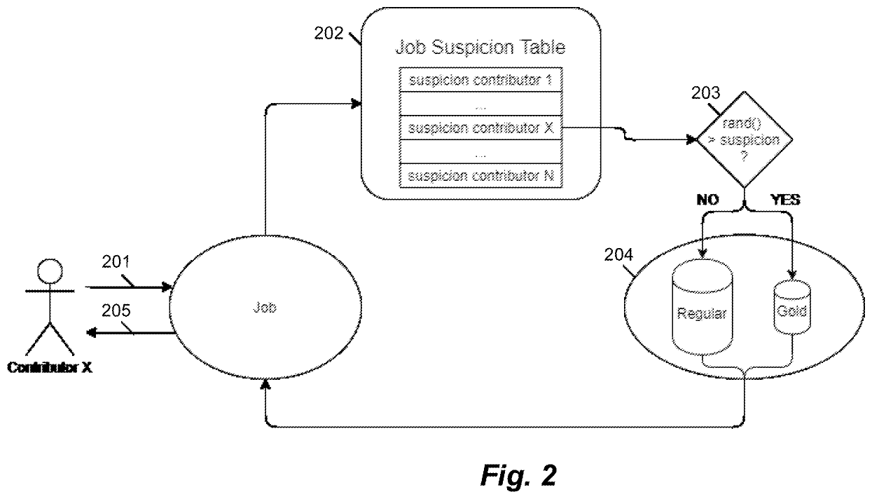

FIG. 2 is a data flow diagram showing the facility's performance of the Assignment Stage for a particular job in some embodiments. In act 201, Contributor X requests the next HIT in the Job to be executed. Each Job has a dedicated Suspicion Table 202, containing one suspicion rate per contributor participating in the job, which is consulted to retrieve the probability of assigning a Gold HIT to Contributor X at that point in time. The facility's population of each job's suspicion table is discussed further below. With this information, in act 203, the facility generates a random number between 0 and 1 and decides whether to assign a Regular or a Gold HIT. The higher the suspicion rate of a contributor, the higher the likelihood of assigning a Gold HIT. In act 204, the system accesses the HIT pool, and retrieves the HIT corresponding to the decision taken in act 203. Finally, in act 205, the facility presents the retrieved HIT to Contributor X.

In some embodiments, the Update Stage occurs every time a Gold HIT is answered. During this stage, the corresponding contributor suspicion rate is updated, i.e., increased if the contributor failed the assessment and decreased otherwise.

### I—Strategy Formulation

In full detail, the Dynamic Gold HIT Assignment Strategy has four components.

1. Maximum and Minimum Suspicion Rates: two thresholds that define, respectively, a ceiling and a floor for the value of suspicion of any contributor in the Job. The Maximum Suspicion Rate allows to diminish returns of over assigning Gold HITs, or a situation where all tasks assigned are Gold, which can enable malicious users to know when they are being evaluated and possibly exploit the platform. The Minimum Suspicion Rate, on the other hand, allows to control for the situation where contributors reach a certain level where they never get assessed.

In some embodiments, the Maximum and Minimum Suspicion Rates are subject to the following criteria:
0<max_suspicion≤1,
0≤min_suspicion<1,
min_suspicion<max_suspicion

2. Suspicion Kernel Function: a suspicion function ƒ(x) that maps a value of confidence (noted by x) to a suspicion rate. This function allows for controlling the degree to which the suspicion rate increases and decreases, according to a given decrease or increase in the confidence associated with the contributor. After establishing both the Maximum and Minimum Suspicion Rates and the Suspicion Kernel Function, the values for minimum and maximum confidence can be extrapolated by the following equations:

min_confidence=ƒ¹(max_suspicion) and,

max_confidence=ƒ¹(min_suspicion)

In some embodiments, it is true of the Suspicion Kernel Function ƒ(x) that:

∀×∈[min_confidence, max_confidence]0≤ƒ(x)≤1,

min_confidence≤max_confidence

These conditions are true, for instance, for any continuous, decreasing function. Table 1 below shows three sample combinations of suspicion kernel functions with minimum and maximum suspicions used by the facility in some embodiments.

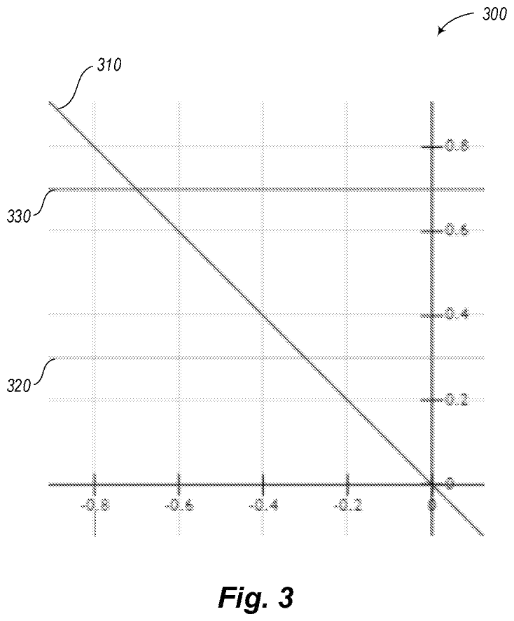

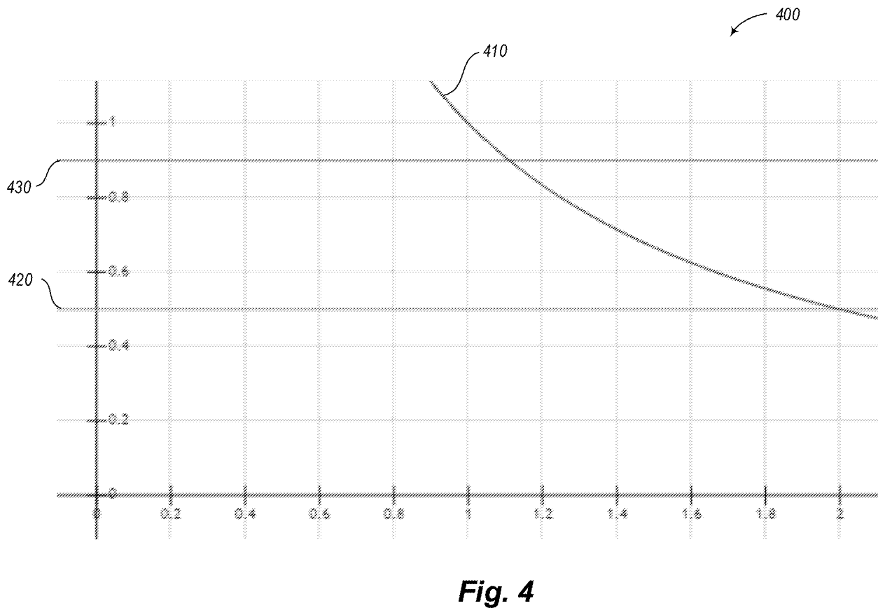

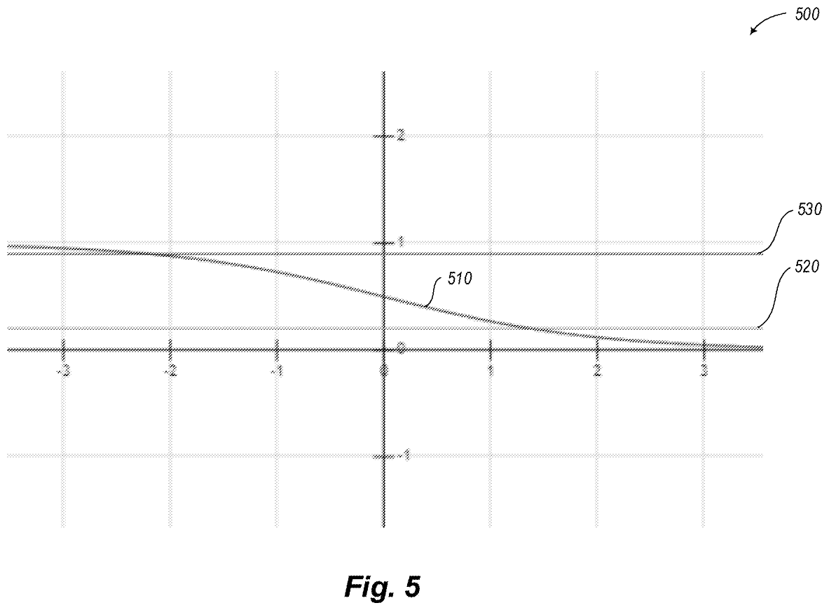

TABLE 1

| Graph | Figure 3 | Figure 4 | Figure 5 |
|---|---|---|---|
| f (x) | −x | [symbol] | sigmoid (−x) |
| max suspicion | 0.7 | 0.9 | 0.9 |
| min suspicion | 0.3 | 0.5 | 0.3 |
| min confidence | −0.7 | ≈−1.11 | ≈−2.19 |
| max confidence | −0.3 | 2 | ≈−1.39 |

FIG. 3 is a graph diagram showing a first combination of a suspicion kernel function with minimum and maximum suspicion used by the facility in some embodiments. The graph 300 corresponds to the first column of Table 1. The suspicion kernel function 310 is ƒ(x)=x; the minimum suspicion 320 is 0.7; and the maximum suspicion 330 is 0.3.

FIG. 4 is a graph diagram showing a second combination of a suspicion kernel function with minimum and maximum suspicion used by the facility in some embodiments. The graph 400 corresponds to the second column of Table 1. The suspicion kernel function 410 is ƒ(x)=1/x; the minimum suspicion 420 is 0.5; and the maximum suspicion 430 is 0.9.

FIG. 5 is a graph diagram showing a third combination of a suspicion kernel function with minimum and maximum suspicion used by the facility in some embodiments. The graph 500 corresponds to the third column of Table 1. The suspicion kernel function 510 is ƒ(x)=sigmoid(−x); the minimum suspicion 520 is 0.3; and the maximum suspicion 530 is 0.9.

3. Starting Suspicion Rate: defines suspicion rate for contributors when starting the job. The corresponding starting confidence can be computed by:

starting_confidence=ƒ⁻¹(starting_supicion)

4. Increasing and Decreasing Confidence Steps: these two values define, for the domain of the chosen suspicion kernel function, the degree of increase and decrease of the confidence (and consequently suspicion) after a given Gold Execution, during the Update Stage. Separating these two values allows for controlling individually the rising and the lowering of the suspicion rate of the contributor.

### II—Setting-up the Dynamic Gold HIT Assignment Strategy

The formulation of the Dynamic Gold HIT Assignment Strategy described above enables strategies customized to best suit each Job. In various embodiments, the facility uses one or more of the following approaches to configuring itself for a Job: expert tuning, historical data optimization, and simulation.

An expert in crowdsourcing or data labeling can use the facility as a comprehensive platform to make decisions on the behavior of the assignment of the gold HITs. In various embodiments, this includes a) deciding that any given contributor should, at least, on average, be exposed to a gold HIT every 20 tasks, thus setting the minimum suspicion to 5%, b) wanting to enforce a linear and balanced variation of the suspicion rate, thus choosing a linear kernel function and equivalent increasing and decreasing confidence steps, c) wanting to use the initial stage of the job as qualification, thus setting a high starting suspicion rate and choosing a slowly decreasing kernel function, or d) rely on the previous contributor reputation on the platform to initialize their suspicion.

The facility of the Dynamic Gold HIT Assignment Strategy also allows for parameter optimization based on historical data on previous collections. In other words, for a given past Job, typically of similar format, what would have been the optimal parameters values so that a) contributors that were blocked in the Job would have done the minimum amount of regular tasks (reactivity) and b) contributors that were not blocked were exposed to the least Gold HITs (cost). Given the reduced number of parameters and variables to be optimized, and thus the low computational costs for simulating large numbers of combinations, it is affordable to run grid searches over pre-defined sets of parameters.

Finally, in the absence of enough context (e.g.: new type of annotation in the platform, and/or most contributors having a short history in the platform), the facility allows for running simulations over common/target scenarios.

### III—Running Simulations for Different Data Collection Scenarios

To allow for simulating different data collection scenarios, the inventors defined the following Contributor Archetypes:
Reckless: fails a large amount of Gold HITs throughout the entire job
Poor successfully answers a Gold HIT occasionally, but shows no improvements over time
Late Spammer starts by doing good contributions but half-way in the job the performance drops
Good: gets most Gold HITs correct
Flawless: gets practically all Gold HITs correct

The Contributor Archetypes are defined by establishing the probability of a given contributor failing a Gold HIT at a certain phase of the job. Table 2 below shows an example of the facility's use of the Contributor Archetypes by dividing the job into four stages (quarters Q1-Q4) and defining the probability of each archetype failing a Gold HIT at each phase.

TABLE 2

| | Q1 | Q2 | Q3 | Q4 |
|---|---|---|---|---|
| Reckless | 90% | 90% | 90% | 90% |
| Poor | 60% | 85% | 85% | 85% |
| Late Spammer | 20% | 20% | 80% | 90% |
| Good | 15% | 15% | 15% | 15% |
| Flawless | 3% | 3% | 3% | 3% |

The archetypes allow for defining distinct Job scenarios, in what concerns the predicted distribution of the behavior of the crowd entering the job. By varying the parameters of the Dynamic Gold HIT Assignment Strategy, it is possible to identify the combination that minimizes the cost of the strategy and maximizes its reactivity.

### IV—In Practice

With the archetypes defined above, three scenarios were prepared varying the distribution of contributors per archetype. Table 3 below resumes such distribution, considering 200 contributors per scenario.

TABLE 3

| | I | II | III |
|---|---|---|---|
| Reckless | 40 | 20 | 5 |
| Poor | 60 | 20 | 10 |
| Late Spammer | 40 | 20 | 5 |
| Good | 35 | 85 | 140 |
| Flawless | 25 | 55 | 40 |

For each of the scenarios above, simulations with different parameter combinations were run over 500 executions. In this specific example, all simulations used the Suspicion Kernel Function sigmoid(−x), which enables taking smaller steps while decreasing towards 0.

Table 4 below summarizes the set of parameters obtained for each of the scenarios. As can be seen, when facing higher rates of Good and Flawless contributors—hence a more trustable crowd—the strategy chooses to assign less Gold HITs at the beginning of the Job (since it trusts the crowd), but penalizes more when a contributor fails a Gold Execution.

TABLE 4

| | I | II | III |
|---|---|---|---|
| Minimum Suspicion Rate | 1.8% | 1.8% | 1.8% |
| Maximum Suspicion Rate | 38% | 38% | 27% |
| Starting Suspicion Rate | 73% | 73% | 38% |
| Increasing Confidence Step | 0.5 | 0.5 | 0.25 |
| Decreasing Confidence Step | 0.25 | 0.25 | 0.5 |

Based on a combination of expertise in crowdsourcing, usage of historical data, and simulation, in some embodiments the facility uses the following default parametrization for the parameters of the Dynamic Gold HIT Assignment Strategy:
Minimum Suspicion Rate: 3%
Maximum Suspicion Rate: 50%
Suspicion Kernel Function: sigmoid(−x)
Starting Suspicion Rate: 38%
Increasing Confidence Step: 0.75
Decreasing Confidence Step: 0.75

Table 5 below compares the assignment of HITs (Gold and Regular) for each of the archetypes when using a Flat Rate Gold HIT Assignment (with 5% as a parameter) versus the Dynamic Assignment (using the parameters mentioned above). The results for the Reckless and Poor contributors show significant gains in reactivity of the job. The new strategy made it possible to block these contributors under 11 regular executions for the Reckless contributor, and under 18 executions for the Poor, contrasting with 118 and 72 regular executions, respectively, in the Flat Rate formulation. This increase in reactivity did not compromise the overall cost of the strategy, since the number of Gold HITs assigned in all archetypes is similar.

TABLE 5

| | Flat Rate (5%) | | Dynamic Assignment | |
|---|---|---|---|---|
| | #Gold | #Regular | #Gold | #Regular |
| | HITs | HITs | HITs | HITs |
| | Assigned | Assigned | Assigned | Assigned |
| Reckless | 8 | 118 | 8 | 11 |
| Poor | 8 | 72 | 8 | 18 |
| Late Spammer | 16 | 282 | 16 | 264 |
| Good | 10 | 250 | 13 | 250 |
| Flawless | 13 | 250 | 12 | 250 |

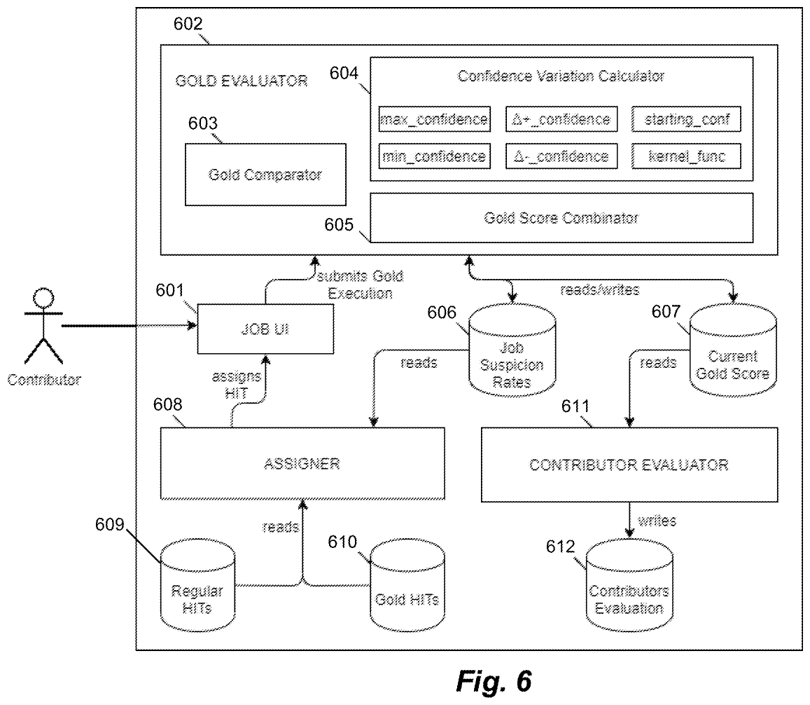

FIG. 6 is an architecture diagram showing a first architecture in which the facility is implemented in some embodiments. The contributor interacts with the system through a Job User Interface 601, where s/he is presented with executions of the current jobs, answers them, and submits the corresponding response.

An Assigner component 608 decides the type of execution to assign to each contributor at a given moment. The Assigner component reads the current contributor suspicion rate from 606 and, depending on the final decision of the assignment process described above in connection with FIG. 2, chooses to retrieve either a regular HIT 609 or a Gold HIT 610.

Upon submission of a Gold HIT Execution, the Gold Evaluator component 602 is activated. A Gold Comparator 603 of the Gold Evaluator applies the appropriate comparison metric (depending on the type of output of the Job) between the contributor's response and the Gold Answer. Based on the job configuration, the Gold Comparator 603 decides whether the Gold Execution passes or fails, and communicates that decision to both the Confidence Variation Calculator 604 and the Gold Score Combinator 605.

The Confidence Variation Calculator module 604 reads the current suspicion rate of the contributor (stored among Job Suspicion Rates 606) and updates it accordingly to the procedures described above in Section I—Strategy Formulation (decreasing confidence if the contributor fails, and increasing it otherwise). The facility computes a new suspicion rate using the Suspicion Kernel Function and stores it among the Job Suspicion Rates 606.

On the other hand, the Gold Score Combinator 605 updates the Gold Score of the contributor, using the information of passed/failed Gold HIT. This involves reading the history of Gold Executions of the contributor in 607, recomputing the new score, and writing the new Gold Score 607.

Finally, the Contributor Evaluator 611 periodically reads the current Gold Score of the contributor 607 and, according to the job configuration in place, produces a given action to be applied to the contributor, storing it as Contributors Evaluation 612 (for instance, decides to prevent the contributor to submit further executions).

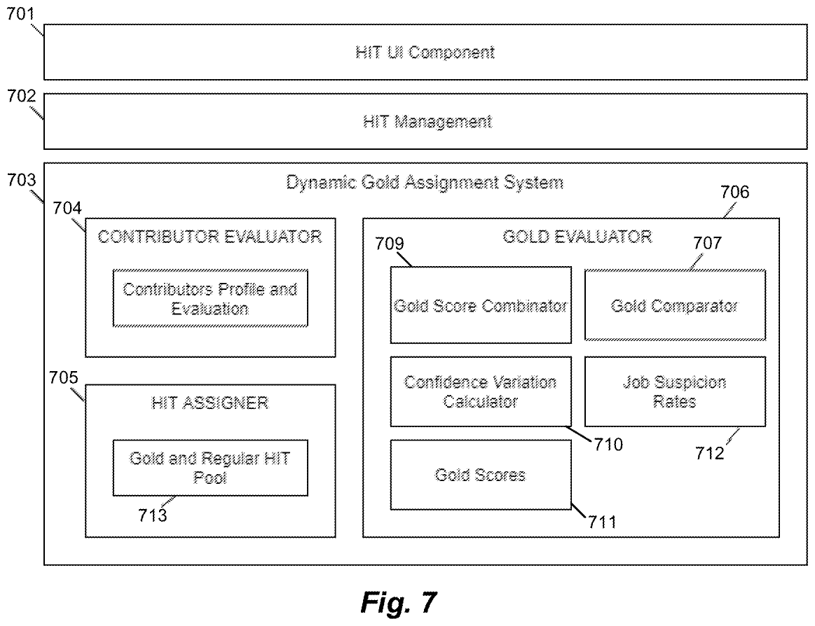

FIG. 7 is an architecture diagram showing a second architecture in which the facility is implemented in some embodiments. The contributor interacts with the facility through a UI component 701, such as a mobile or web UI component. The UI component presents the contributor with HITs of the job, and receives and submits contributor responses. All of these flows are managed by a HIT management component 702.

In a Dynamic Gold Assignment System 703, a HIT Assigner component 705 is responsible for deciding the type of execution to assign to each contributor at a given moment based on contributor suspicion rate 606. Depending on the final decision, the facility chooses to retrieve either a regular HIT or a gold HIT from HIT Pool 713.

Upon submission of a gold HIT Execution, the Gold Evaluator component 706 is activated. The Gold Comparator 707 applies the appropriate comparison metric (depending on the type of output) between the contributor's response and the gold answer. Based on the job configuration, the Gold Comparator 707 decides whether the HIT execution passes or fails, and communicates that decision to both the Confidence Variation Calculator 710 and the Gold Score Combinator 709.

The Confidence Variation Calculator module 710 reads the current suspicion rate of the contributor, stored among Job Suspicion Rates 712, and updates it accordingly to the procedures described above in Section I—Strategy Formulation (decreasing confidence if the contributor fails, and increasing it otherwise). The new suspicion rate is computed using the Suspicion Kernel Function and is then stored among Job Suspicion Rates 712.

On the other hand, the Gold Score Combinator 709 updates the Gold Score of the contributor, using the information of passed/failed Gold HIT. This involves reading the history of Gold Executions of the contributor and recomputing the new score.

Finally, the Contributor Evaluator 704 periodically reads the current Gold Score of the contributor and, according to the configuration in place, produces a given action to be applied to the contributor. For instance, decides to prevent the contributor to submit further executions.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computing system, comprising:
one or more processors; and
one or more memories collectively having contents adapted to be executed by the one or more processors to cause the instantiation and operation of a dynamic gold HIT assignment system with respect to a contributor, the dynamic gold HIT assignment system comprising:
a gold comparator configured to determine whether a gold HIT assigned to the contributor by a HIT assigner was answered correctly;
a confidence calculator configured to adjust a confidence score for the contributor based on whether the gold comparator determined that the gold HIT was answered correctly;
a suspicion calculator configured to use a suspicion kernel function to determine an updated suspicion level for the contributor from the adjusted confidence score;
the HIT assigner configured to determine, for each HIT execution to be assigned to the contributor, whether to assign a gold HIT or a regular HIT based on combining a source of randomness with the adjusted confidence score; and
a gold score combinator configured to maintain a gold score for the contributor by aggregating the results for gold HITs assigned to the contributor determined by the gold comparator.

2. The computing system of claim 1, the dynamic gold HIT assignment system further comprising a HIT user interface component configured to present to the contributor HITs assigned to the contributor by the HIT assigner and receive from the contributor answers to the presented HITs.

3. The computing system of claim 1, the dynamic gold HIT assignment system further comprising a confidence initializer configured to initially set the confidence score to a starting confidence score.

4. The computing system of claim 1 wherein the confidence calculator is further configured to increase the confidence score by an increasing confidence step where the gold comparator determines that the gold HIT was answered correctly, and decrease the confidence score by a decreasing confidence step where the gold comparator determines that the gold HIT was answered incorrectly.

5. The computing system of claim 1 wherein the confidence variation calculator is further configured to constrain the adjusted confidence score between a minimum confidence score and a maximum confidence score.

6. The computing system of claim 1, the dynamic gold HIT assignment system further comprising a contributor evaluator compares the gold score maintained for the contributor by the gold score combinator to a gold score threshold to determine whether to suspend the HIT assigner's assignment of HITs to the contributor.

7. One or more computer memories collectively having contents configured to cause a computing system to perform a method with respect to a crowdsourcing platform contributor, the method comprising:
first determining, by combining a first probability value for the contributor with a source of randomness, that a gold HIT should be presented to the contributor;
in response to the first determining, presenting a gold HIT to the contributor;
receiving a response to the presented gold HIT;
where the received response is correct, reducing the first probability value to obtain a second probability value;
where the received response is incorrect, increasing the first probability value to obtain the second probability value; and
second determining, by combining the second probability value with a source of randomness, whether a gold HIT or a regular HIT should next be presented to the contributor.

8. The one or more computer memories of claim 7, the method further comprising:
next presenting to the contributor a gold HIT or a regular HIT in accordance with the second determining.

9. The one or more computer memories of claim 7 wherein reducing the first probability value to obtain a second probability value comprises:
increasing by an increasing confidence step a first confidence value for the contributor corresponding to the first probability value; and
subjecting the increased first confidence value to a suspicion kernel function to obtain the second probability value,
and wherein increasing the first probability value to obtain a second probability value comprises:
reducing by a decreasing confidence step the first confidence value for the contributor corresponding to the first probability value; and
subjecting the reduced first confidence value to the suspicion kernel function to obtain the second probability value.

10. The one or more computer memories of claim 9 wherein the presented gold HIT is of a distinguished job type, the method further comprising:
empirically determining the increasing confidence step, the decreasing confidence step, and the suspicion kernel function with respect to HITs of the distinguished job type.

11. The one or more computer memories of claim 9 wherein the presented gold HIT is of a distinguished job type, the method further comprising:
determining the increasing confidence step, the decreasing confidence step, and the suspicion kernel function with respect to HITs of the distinguished job type via simulation, by:
dividing jobs of the job type into a plurality of phases;
for each of a plurality of contributor archetypes, determining a probability that contributors of the contributor archetype will fail at each of the phases;
for each of a plurality of simulation scenarios:
establishing a distribution of simulation scenario contributors across contributor types;
operating a simulation in accordance with the simulation scenario; and
selecting the increasing confidence step, the decreasing confidence step, and the suspicion kernel function with respect to HITs of the distinguished job type on the basis of the operated simulations.

12. The one or more computer memories of claim 7, the method further comprising:
bounding the second probability value within an acceptable range of probability values.

13. The one or more computer memories of claim 7, the method further comprising:
where the received response is correct, reducing an accuracy score for the contributor to obtain an adjusted accuracy score;
where the received response is incorrect, increasing the accuracy score to obtain an adjusted accuracy score;
if the adjusted accuracy score is below an accuracy threshold, suspending the presentation of HITs to the contributor.

14. A method in a computing system performed with respect to a crowdsourcing platform contributor, the method comprising:
first determining, by combining a first probability value for the contributor with a source of randomness, that a gold HIT should be presented to the contributor;
in response to the first determining, presenting a gold HIT to the contributor;
receiving a response to the presented gold HIT;
where the received response is correct, reducing the first probability value to obtain a second probability value;
where the received response is incorrect, increasing the first probability value to obtain the second probability value; and
second determining, by combining the second probability value with a source of randomness, whether a gold HIT or a regular HIT should next be presented to the contributor.

15. The method of claim 14, the method further comprising:
next presenting to the contributor a gold HIT or a regular HIT in accordance with the second determining.

16. The method of claim 14 wherein reducing the first probability value to obtain a second probability value comprises:
increasing by an increasing confidence step a first confidence value for the contributor corresponding to the first probability value; and
subjecting the increased first confidence value to a suspicion kernel function to obtain the second probability value,
and wherein increasing the first probability value to obtain a second probability value comprises:
reducing by a decreasing confidence step the first confidence value for the contributor corresponding to the first probability value; and
subjecting the reduced first confidence value to the suspicion kernel function to obtain the second probability value.

17. The method of claim 16 wherein the suspicion kernel function is a decreasing continuous function.

18. The method of claim 16 wherein the presented gold HIT is of a distinguished job type,
the method further comprising:
empirically determining the increasing confidence step, the decreasing confidence step, and the suspicion kernel function with respect to HITs of the distinguished job type.

19. The method of claim 14, further comprising:
bounding the second probability value within an acceptable range of probability values.

20. The method of claim 14, further comprising:
where the received response is correct, reducing an accuracy score for the contributor to obtain an adjusted accuracy score;
where the received response is incorrect, increasing the accuracy score to obtain an adjusted accuracy score;
if the adjusted accuracy score is below an accuracy threshold, suspending the presentation of HITs to the contributor.
